(19) United States
(12) Patent Application Publication
(10) Pub. No.: US 2026/0135750 A1
(43) Pub. Date: May 14, 2026

(54) METHOD AND CIRCUIT ARRANGEMENT FOR CONSTANT ENVELOPE MODULATION

(71) Applicant: Skyworks Solutions, Inc., Irvine, CA (US)

(72) Inventor: David Richard Pehlke, Westlake Village, CA (US)

(21) Appl. No.: 19/363,808

(22) Filed: Oct. 21, 2025

Related U.S. Application Data
(60) Provisional application No. 63/718,029, filed on Nov. 8, 2024.

(51) Int. Cl. H04L 27/36

(52) U.S. Cl. CPC H04L 27/366; H04L 27/361

(57) ABSTRACT

Aspects of the present disclosure relate to a method for constant envelope modulation. The method includes processing a first time-domain in-phase and quadrature (I/Q) composite signal, processing a second time-domain I/Q composite signal, combining the first time-domain I/Q composite signal and the second time-domain I/Q composite signal into a doublet pair signal, and forming a sum of the first waveform and the second waveform to obtain a constant envelope. The first time-domain I/Q composite signal is described by a first waveform and contains an intended high order modulation with a high peak-to-average ratio (PAR) and an envelope modulation as a function of time, and the second time-domain I/Q composite signal is described by a second waveform with an envelope change over time and a phase change over time of the second waveform defined as a function of the first waveform.

### CROSS REFERENCE TO RELATED APPLICATIONS

This application claims priority, under 35 U.S.C. § 119(e), to U.S. Provisional Patent Application 63/718,029, titled METHOD AND CIRCUIT ARRANGEMENT FOR CONSTANT ENVELOPE MODULATION, filed on Nov. 8, 2024, and hereby incorporated by reference in its entirety for all purposes.

### BACKGROUND

### Field

The present disclosure relates to a method for constant envelope modulation. The present disclosure further relates to a circuit arrangement and a mobile device for same.

### Description of the Related Technology

Quadrature amplitude modulation (QAM) is used extensively as a modulation scheme for digital telecommunication systems, such as in Long Term Evolution (LTE), in some of the 802.11 Wi-Fi standards, and in fifth-generation New Radio (5G NR). By moving to a high-order QAM, it is possible to arrive at faster transmission rates. In addition to the benefits brought by high-order QAM, it should also be noted that high-order QAM has an impact on the peak-to-average ratio (PAR) of the modulated waveforms.

The PAR level, usually expressed in dB, is the power level of the highest instantaneous power compared to the average power level of the waveforms. A PAR of 1, or 0 dB, means the signal is of constant power, so the peak power is equal to the average power. A high PAR means that the signal power fluctuates occasionally to a very large value.

In high-order QAM, when the coherence and destructive interference of many independently changing waveforms interact, they produce a statistical profile where the occasional large coherence interference drives extremely high peaks in the envelope of the overall signal, and the occasional destructive interference drives extremely low peaks in the envelope of the overall signal. Transmission with higher-order QAM has historically resulted in higher PAR in the modulated waveforms. A high PAR requires the linear transmit amplification circuits to operate over a wide power range and means that a significant amount of the energy generated by the power amplifier is wasted and converted into heat, thus degrading the efficiency of the power amplifier.

### SUMMARY OF THE INVENTION

There is a desire to provide an improved transmit system to address the degraded performance brought about by high PAR without compromising the data rate capability and transmit efficiency.

Aspects and embodiments of the present disclosure address the degraded performance brought about by high PAR in the transmit system during high-order QAM modulation by specific measures of constant envelope modulation. This increases the efficiency of the transmit system and enables the overall transmit system to operate closer to the saturated maximum power limit.

Previous solutions to address the degraded performance brought by high PAR in the transmit system included envelope trackers to adjust the power envelope signal dynamically in the transmit system, or used different modulation schemes, such as single-carrier frequency-division multiple access, SC-FDMA, π/2-binary phase-shift keying, π/2-BPSK or the like, to reduce the order of the modulation. However, the previous methods either increase the complexity of the system and thus the cost, or require more latency so that the data rate capability of the transmit system is negatively impacted.

Aspects and embodiments of the present disclosure provide a significantly improved constant envelope modulation which assures the spectrum diversity of the transmit signal and at the same time reduces the negative effect of the transmit system brought by high PAR in high-order QAM modulation.

A first time-domain I/Q composite signal carries the source information and contains the intended higher order modulation with a high PAR and the envelope modulation as a function of time. In order to achieve the constant envelope property of the modulation, a second time-domain I/Q composite signal is designed that is dependent on the first time-domain I/Q composite signal. The first time-domain I/Q composite signal and the second time-domain I/Q composite signal are combined to a doublet pair signal. The first time-domain I/Q composite signal is described by a first waveform S₁(t)=A(t) cos (ω₁t+φ(t)), in which the first time-domain I/Q composite signal contains an intended high order modulation with a high PAR and an envelope modulation as a function of time. The second time-domain I/Q composite signal is described by a second waveform S₂(t)=B(t) cos (ω₂t+θ(t)), in which an envelope change over time and a phase change over time of the second waveform are defined as a function of the first waveform. A(t) and B(t) represent the envelope change over time of the first time-domain I/Q composite signal and the second time-domain I/Q composite signal, respectively. ω₁ and ω₂ represent an angular frequency of the first time-domain I/Q composite signal and the second time-domain I/Q composite signal, respectively, φ(t) and θ(t) represent the phase change over time of the first time-domain I/Q composite signal and the second time-domain I/Q composite signal, respectively. The second time-domain I/Q composite signal is designed such that a sum of the first waveform and the second waveform results in a constant envelope.

The method for constant envelope modulation is further applied in a circuit arrangement that has the specific ability to execute such a method for constant envelope modulation. The circuit arrangement is further implemented in a mobile device. Advantageous configurations and developments emerge from the further dependent claims and from the description with reference to the figures of the drawings.

In one configuration of the method, the angular frequencies ω₁ and ω₂ are separated by a predefined difference. As commonly known, an angular frequency ω can be represented by 2πf, including an ordinary frequency f. The frequencies of the first subcarrier wave and the second subcarrier wave are represented by the ordinary frequency f₁ and the ordinary frequency f₂ linked with ω₁ and ω₂, respectively. Therefore, f₁ and f₂ are also separated by a predefined difference. The predefined difference between f₁ and f₂ is defined as the composition of the offset of f₁ from the local frequency at one side and the offset of f₂ from the local frequency at the other side, in which those two offsets are symmetrical. The local frequency can be defined as the central frequency of one of the subcarriers or one of the groups of subcarriers. The predefined difference between f₁ and f₂ is time-dependent and also dependent on the location of the offset of f₁ from the local frequency. In other words, different doublet pair signals may have different predefined differences between f₁ and f₂. Therefore, the flexibility of the subcarrier frequency adjustment of different doublet pair signals is realized. The change of f₂ can tracked the change of f₁, so that the dependency of the second waveform on the first waveform is ensured as well.

In one configuration of the method, B(t), the envelope change over time and θ(t), the phase change over time of S₂(t), the second waveform, are designed to be directly dependent on S₁(t), the first waveform. The generation of the second waveform may be after the generation of the first waveform. The first waveform carries the source information that needs to be transmitted, whereas the second waveform is generated dependent on the first waveform without the need to transfer additional source information. Generating the second waveform dependent on the first waveform substantially cancels the envelope variation and generates a constant envelope of the transmitted signal. The transmitted signal is the doublet pair signal combined by the first time-domain I/Q composite signal and the second time-domain I/Q composite signal. Therefore, the envelope change over time and the phase change over time of the second waveform should be designed to enable the second waveform to adjust its waveform relative to the first waveform, such that the envelope variation of the doublet pair signal can be cancelled with the combination of the second waveform, and the constant envelope of the doublet pair signal can be achieved.

In one configuration of the method, the envelope change over time of the second time-domain I/Q composite signal B(t) is represented by:

$$B ( t ) = \frac{1 - A ( t ) cos ( {ω}_{1} t + φ ( t ) )}{cos ( {ω}_{2} t + θ ( t ) )} ,$$

wherein the phase change over time of the first time-domain I/Q composite signal and the second time-domain I/Q composite signal comprises at least one of the following correlations: θ(t)=φ(t);

$$θ ( t ) = \frac{π}{2} - φ ( t ) ;$$

θ(t)=π−φ(t). In this configuration, an example of the envelope change over time and the phase change over time of the second waveform designed in dependence on the first waveform is illustrated. A(t), the envelope change over time of the first time-domain I/Q composite signal and φ(t), the phase change over time of the first time-domain I/Q composite signal are modulated as a normalized and nominal targeted value of the doublet pair signal. The property of high PAR and the envelope variation of the first waveform are also inherited, which means the source information of the first time-domain I/Q composite signal is also inherited, but the average power of the first time-domain I/Q composite signal is below a predefined constant value. The predefined constant value may be referred to as a constant saturation power of a power amplifier located in the transmit path. In this case, the predefined constant value can be presupposed as 1, as the common value chosen by a number of other normalization processes. Depending on the magnitude of the constant saturation power of the power amplifier, other predefined constant values can also be selected.

In at least one configuration of the method, the second waveform is entirely dependent on the first waveform. Other correlations between the phase change over time of the first time-domain I/Q composite signal and the second time-domain I/Q composite signal, and between the envelope change over time of the first time-domain I/Q composite signal and the second time-domain I/Q composite signal can also be selected. It is sufficient that those correlations fulfil the requirements of the constant envelope modulation method proposed in this disclosure. The source information is carried by the first waveform. The second waveform is generated dependent on the first waveform without the need to transfer additional source information. Thus, the generation of the second waveform may be completed based on the frequency, envelope change over time, and phase change over time of the first waveform, rather than being generated from additional source information added to the transmission information. The generation of the second waveform may require the use of a few digital signal processing steps after the first time-domain I/Q composite signal is produced from the first frequency-domain I/Q composite signal.

In at least one configuration, the method is applied in at least one of the following modulation schemes: QAM and quadrature phase-shift keying (QPSK). QAM is a modulation scheme that moderates two bit streams onto two carrier waves called an in-phase carrier wave and a quadrature carrier wave. In any event, the in-phase carrier wave and the quadrature carrier wave may refer to two sinusoids that have the same frequency but are 90° out of phase. Alternatively, the in-phase carrier wave may be a cosine waveform and the quadrature carrier wave may be a sine waveform, since a sine wave is shifted by 90° relative to a cosine wave. In a QAM modulation scheme, before the signal can be transmitted, the signal bits have to be mapped to a constellation diagram and each point in the constellation diagram is known as a symbol.

The process whereby a certain number of signal bits are assigned to each symbol is called mapping. Each symbol can be represented by a complex signal on the constellation diagram. A complex signal is a two-dimensional (2D) signal whose value can be specified by a single complex number having two parts: a real part and an imaginary part. The real part signal and the imaginary part signal can be modulated onto the in-phase carrier wave and quadrature carrier wave, respectively. In fact, QPSK is a special type of QAM. QPSK can encode two bits per symbol. Therefore, QPSK is also known as 4-QAM. QAM can be 16-QAM, 32-QAM, 64-QAM or higher order. By moving to a higher-order constellation, it is possible to transmit more bits per symbol. 16-QAM can encode four bits per symbol, 32-QAM can encode five bits per symbol and 64-QAM can encode eight bits per symbol. Through the use of QAM and even higher orders of QAM, higher data rates are achieved within a given bandwidth. Enabling the modulation both on the amplitude and phase, QAM can also increase the spectral efficiency.

In at least one configuration of the method, the method is employed in at least one of the following multiplexing techniques: frequency-division multiplexing (FDM), orthogonal frequency-division multiplexing (OFDM), and orthogonal frequency-division multiple access (OFDMA). An FDM system simply separates different channels by assigning different frequency spectra for each channel. An OFDM system combines the benefits of QAM and FDM. In OFDM, multiple closely spaced orthogonal subcarriers with overlapping spectra are transmitted, with each subcarrier modulated with one symbol from the incoming stream so multiple symbols are transmitted in parallel. An OFDMA system allows multiple users to reuse channel resources by allocating subcarriers to different users and adding multiple accesses in the OFDM system, whereas in OFDM systems, one user occupies all subcarriers on a channel and sends a complete data packet. The proposed method is compatible with different multiplexing techniques and therefore retains high data rates and a wide spectrum.

In at least one configuration, before providing the first time-domain I/Q composite signal, the method further comprises converting first input information into a first binary stream; correcting the first binary stream into a corrected first binary stream; mapping the corrected first binary stream into symbols; and providing a first I baseband signal and a first Q baseband signal by splitting symbols into I and Q components.

The step of converting the first input information into a first binary stream may also be called source coding. The first input information may be any analog signal and/or digital signal that can be measured or otherwise obtained, for example, text, voice, notes, images, videos, or the like. The analog signals need to be converted into a suitable binary stream using at least one analog-digital converter (ADC), such that the signal can be processed by employing a processor or a programmable device. This may involve compressing and encoding the original analog data using techniques such as Huffman coding, Joint Photographic Experts Group (JPEG) or other forms of source encoding.

The step of correcting of the first binary stream can be referred to as altering or adjusting the binary stream, such as to bring it into accordance with a standard or with a required condition that is less prone to errors or less sensitive to noise. The step of correcting the first binary stream into a corrected first binary stream can comprise a plurality of steps, such as a channel coding step, an interleaving step, a scrambling step and other steps that can be used to correct the binary stream. The first binary stream may be the binary stream that was transformed from an analog signal, or may be digital signals obtained directly from the source of information.

The channel coding step can be referred to as introducing extra binary bits that help to detect and correct potential errors introduced by noise and interference during the signal transmission. In the interleaving step, the binary stream with the extra binary bits is rearranged, such that the binary stream is less susceptible to burst errors by spreading out errors over time, improving the performance of the error correction process. In the scrambling step, the binary stream is processed to ensure that the signal has a more uniform distribution of ones and zeros, which is beneficial for clock recovery and reduces the likelihood of long sequences of the same bits.

The step of mapping the corrected first binary stream into symbols may be referred to as mapping the encoded bits into symbols which represent different amplitude and phase combinations for QAM. The signal bits are mapped to the constellation diagram and each point in the constellation diagram is known as a symbol. The process that a certain number of signal bits are assigned to each symbol is called mapping. The step of providing the first I baseband signal and the first Q baseband signal by splitting symbols into I and Q components refers to the representation of a symbol by a complex signal on the constellation diagram. A complex signal is a two-dimensional (2D) signal whose value can be specified by a single complex number having two parts: a real part and an imaginary part. The real part signal and the imaginary part signal can be modulated onto the in-phase carrier wave and quadrature carrier wave, respectively.

In at least one configuration, before providing the first time-domain I/Q composite signal, the method further comprises producing a first modulated I baseband signal and a first modulated Q baseband signal by modulating the first I baseband signal and the first Q baseband signal onto a first subcarrier wave, respectively; and producing a first frequency-domain I/Q composite signal by combining the first modulated I baseband signal and the first modulated Q baseband signal. For the step of producing a first modulated I baseband signal and a first modulated Q baseband signal by modulating the first I baseband signal and the first Q baseband signal onto a first subcarrier wave, the first I baseband signal is multiplied by the first subcarrier wave with a sinusoidal form that has a predefined frequency, the first Q baseband signal is multiplied by the first subcarrier wave with a sinusoidal form that is 90° out of phase and the same predefined frequency. The first Q baseband signal may be multiplied by the first subcarrier wave with a cosine form. The first I baseband signal can be the real part signal of the complex signal. The first Q baseband signal can be the imaginary part signal of the complex signal. The first subcarrier wave can be either the in-phase carrier wave or quadrature carrier wave, depending on whether the I baseband signal or the Q baseband signal is being modulated. For the step of producing a first frequency-domain I/Q composite signal by combining the first modulated I baseband signal and the first modulated Q baseband signal, the first frequency-domain I/Q composite signal may be produced by the addition or sum of the first modulated I baseband signal and the first modulated Q baseband signal.

In at least one configuration of the method, the first I/Q time-domain composite signal is provided by performing an Inverse Fast Fourier transform, IFFT, on the first frequency-domain I/Q composite signal. The first first-frequency domain I/Q composite signal may refer to one of the subcarrier signals of the OFDM or OFDMA system that carries one symbol. A single subcarrier that carries one symbol and occupies one time slot is defined as a resource element. The resource element is the smallest defined unit for allocating time-frequency resources in the physical layer of the communication model. The series of binary signal bits is encoded in different symbols and therefore is converted into parallel binary signal bits. The envelope change over time and the phase change over time of the first waveform in this configuration may represent one of the symbol intervals.

In at least one configuration of the method, the first I/Q time-domain composite signal is further provided by aggregating a plurality of first frequency-domain I/Q composite signals that are modulated onto a plurality of first subcarriers with a predetermined frequency spacing and performing an IFFT on the plurality of first frequency-domain I/Q composite signals. The plurality of first frequency-domain I/Q composite signals may refer to one of the subcarrier groups of the OFDM or OFDMA system that carries one group of symbols. The OFDM and OFDMA system can be implemented based on different communication protocols, such as LTE, Wi-Fi, 5G NR or the like. To increase the transmission efficiency, there may be a group of subcarriers with a group of first subcarrier waves that carries a group of symbols in the OFDM and OFDMA system. The frequency of the first subcarrier waves in the group of first subcarrier waves may be separated by a predetermined frequency spacing according to different communication protocols. The predetermined frequency spacing can be determined for the LTE, Wi-Fi standards, or 5G NR systems. For example, in LTE, the adjacent first subcarrier waves may have a spacing of 15 kHz. In Wi-Fi standards, the adjacent first subcarrier waves may have a spacing of 78.125 kHz in Wi-Fi 6 or 312.5 kHz in 802.11ab/g/n/ac Wi-Fi standards. In 5G NR, the adjacent first subcarrier waves may be determined by the types of 5G NR numerology. For example, the spacing of the adjacent first subcarrier waves is 15 kHz when the numerology value is 0, the spacing is 30 kHz when the numerology value is 1, the spacing is 60 kHz when the numerology value is 2, etc. A transmission is scheduled in group(s) of 12 subcarriers and occupies one time slot, known as a physical resource block. The first time-domain I/Q composite signal can be obtained by preforming an IFFT on the plurality of first frequency-domain I/Q composite signal and represents a time-domain signal based on one resource block.

In at least one configuration of the method, after producing the first time-domain I/Q composite signal, the method further comprises adding a cyclic prefix related to the first time-domain I/Q composite signal to each symbol of the first time-domain I/Q composite signal. After the IFFT, a cyclic prefix, a copy of the end of each symbol, may be added to each symbol to prevent inter-symbol interference, ISI, due to multipath fading in the wireless channel. The cyclic prefix can also be added to each group of symbols for a group of subcarriers in an OFDM or OFDMA system, in this case, the cyclic prefix refers to a copy of the end of each group of symbols.

In at least one configuration of the method, the second time-domain I/Q composite signal comprises a redundancy. The second waveform is generated in dependence on the first waveform. The second waveform may comprise a certain number of extra waveform segments, such as to allow for redundant waveform segments that can be corrected in time due to transient errors.

In at least one configuration of the method, the second waveform comprises a waveform diversity introduced by the redundancy to enable the second waveform to dynamically adapt with the first waveform. The redundancy introduced in the second waveform may further be used to provide waveform diversity, such that the second waveform may adapt with the change of the first waveform with more flexibility. The change of the first waveform may be present due to the transient errors or the requirement for adapting different over-the-air channels.

In at least one configuration, the method further comprises up-converting the doublet pair signal into a combined radio-frequency, RF, signal; producing a transmit RF signal by amplifying the combined RF signal; and producing an output RF signal by filtering the transmit RF signal. When modulating signals, especially at very high frequencies, e.g., in radio frequency or microwave communications, it is common to modulate the signal first at an intermediate frequency, IF, before up-converting it to the final carrier frequency, RF. IF may refer to the central frequency of first subcarrier wave or the group of first subcarrier waves. This two-step process-modulating at IF, then converting to RF-makes signal processing easier and reduces complexity, especially in hardware design. In OFDM systems, according to different communication protocols, there may be different subcarrier groups that contain a different number of tones. For example, 12 subcarriers in one subcarrier group for the LTE protocols. Through digital signal processing, the whole group of the OFDM subcarriers is up-converted with a higher radio frequency. For the step of producing a transmit RF signal by amplifying the combined RF signal, the transmit path in the transmit component comprises at least one amplifier, wherein the amplifier is a power amplifier configured to amplify RF signals with low-power through the transmit path. Typically, power amplifiers are used with their output driving the antenna in the transmit mode. Power amplifiers ensure that the signal is boosted to a predefined level or a level suitable for efficient and reliable signals over long distances. For the step of producing an output RF signal by filtering the transmit RF signal, the transmit path in the transmit component comprises at least one filter, wherein the filter is a transmit filter configured to filter RF signals through the transmit path. The transmit filter processes the RF signal before its transmission. During transmit signal processing, a series of operations, such as signal mixing, spectrum shaping and the like, are introduced. In this process, the entire transmission signal will introduce various unwanted harmonics or noise, increasing the adjacent channel interference and impairing the SNR. Therefore, the filter may be needed or desired to filter the unwanted interference or noise introduced in the transmit RF signal.

In at least one configuration of the method, the doublet pair signal comprises an available bandwidth. The first waveform uses a first half of the available bandwidth. The first waveform contains the input information that the user actually want to transmit. The second waveform is designed to adapt with the first waveform in order to cancel the envelop change over time of the doublet pair signal, such as to enable a constant envelope transmission. Therefore, the second waveform does not contain additional information that the user needs to transmit, instead, the second waveform can be considered as also carrying the information encoding of the first waveform. For a doublet pair signal, the first waveform only takes half of the bandwidth of the available bandwidth of the doublet pair signal.

In at least one configuration of the method, the second waveform uses a second half of the available bandwidth. The predefined difference of f₁ and f₂ is defined as two symmetric offsets from respective f₁ and f₂ to local frequency, the predefined difference can be considered as the available bandwidth of the doublet pair signal. Since the first half of the bandwidth is already taken by the first waveform, the second half of the bandwidth is taken by the second waveform.

In at least one configuration of the method, a total bandwidth of a transmit channel is made up by packing with every doublet pair signal. Each resource element or resource block of the OFDM or OFDMA system can refer to a doublet pair signal. Each doublet pair signal has its available bandwidth, the whole bandwidth of the transmit channel is aggregated with each doublet pair signal.

In at least one configuration of the method, the transmit channel with a plurality of doublet pair signals comprises a property of constant envelope. The first waveform may be modulated as a nominal targeted value of the doublet pair signal, the second waveform is designed in dependence on the first waveform to result in a constant envelope. The whole transmitting channel is aggregated with each doublet pair signal with the constant envelope. Therefore, the whole transmit channel comprises also the constant envelope.

In at least one configuration of the method, the method operates without amplitude modulation (AM) noise contribution. Since the whole transmit channel has the constant envelope, the envelope of the time-domain signal over time is also constant. Thus, the method operates without AM noise contribution or at least with significantly reduced AM noise contribution.

In at least one configuration of a circuit arrangement, the circuit arrangement comprises at least one baseband processor coupled to or being part of at least one transceiver. In a transmit path, a baseband processor usually allows the source information to be processed in the digital domain between the source of the information and the transceiver device. A transceiver is the combination of a transmitter and a receiver in a single unit or device. In a transmit path, the transceiver represents the transmitter of the communication system and forms an interface between the signal in the digital domain and the signal in the RF analog domain. Technically speaking, a transceiver is also commonly known as a modem, since a modem-similar to a transceiver—is also configured to send as well as receive signals. With the development of the integrated circuit, the boundaries between baseband processor and transceiver are becoming blurred. A baseband processor can be part of the transceiver; a transceiver can also be part of the baseband processor. Therefore, it is possible that the functions performed by baseband processor and transceiver in this application are mutually inclusive.

In at least one configuration of the circuit arrangement, the at least one baseband processor is configured to convert first input information into a first binary stream; to correct the first binary stream into a corrected first binary stream; to map the corrected first binary stream into symbols; and to provide the first I baseband signal and the first Q baseband signal by splitting symbols into I and Q components. The step of converting first input information into a first binary stream may also be called source coding. The first input information may be any analog signals or digital signals that can be measured or can be otherwise obtained, for example, text, voice, notes, images, videos, or the like. The analog signals need to be converted into a binary stream using at least one ADC, such that the signal can be processed by processors or a processor device. This may involve compressing and encoding the original analog data using techniques such as Huffman coding, JPEG, or other forms of source encoding. The correcting of the first binary stream can be referred to as altering or adjusting the binary stream so as to bring it into accordance with a standard or with a required condition that is less prone to errors or less sensitive to noise. The step of correcting the first binary stream into a corrected first binary stream can comprise a plurality of steps, such as a channel coding step, an interleaving step, a scrambling step and other steps that can be used to correct the binary stream. The first binary stream may be the binary stream that is transformed from an analog signal, or may be the digital signals obtained directly from the source of information. The channel coding step can be referred to as introducing extra binary bits that help to detect and correct potential errors introduced by noise and interference during the signal transmission. In the interleaving step, the binary stream with the extra binary bits is rearranged, such that binary stream is less susceptible to burst errors by spreading out errors over time, improving the performance of the error correction process. In the scrambling step, the binary stream is processed to ensure that the signal has a more uniform distribution of ones and zeros, which is beneficial for clock recovery and reduces the likelihood of long sequences of the same bits. The mapping of the corrected first binary stream into symbols step refers to mapping the encoded bits into symbols, which represent different amplitude and phase combinations for QAM. The signal bits are mapped to the constellation diagram and each point in the constellation diagram is known as a symbol. The providing the first I baseband signal and the first Q baseband signal by splitting symbols into I and Q components step refers to the representation of symbol by a complex signal on the constellation diagram. A complex signal is a two-dimensional (2D) signal whose value can be specified by a single complex number having two parts: the real part and the imaginary part. The real part signal and the imaginary part signal can be modulated onto the in-phase carrier wave and quadrature carrier wave, respectively.

In at least one configuration of the circuit arrangement, the at least one transceiver is further configured to: produce a first modulated I baseband signal and a first modulated Q baseband signal by modulating the first I baseband signal and the first Q baseband signal onto a first subcarrier wave, respectively; and produce a first frequency-domain I/Q composite signal by combining the first modulated I baseband signal and the first modulated Q baseband signal. In this configuration, the at least one transceiver comprises at least one modulator that is configured to produce a modulated first I baseband signal and a modulated first Q baseband signal by modulating the first I baseband signal and the first Q baseband signal onto a first subcarrier wave, respectively. The at least one transceiver further comprises at least one mixer that is configured to combine the modulated first I baseband signal and the modulated first Q baseband signal to produce a first frequency-domain I/Q composite signal. For the step producing a first modulated I baseband signal and a first modulated Q baseband signal by modulating the first I baseband signal and the first Q baseband signal onto a first subcarrier wave, the first I baseband signal is multiplied by the first subcarrier wave with a sinusoidal form that has a predefined frequency, the first Q baseband signal is multiplied by the first subcarrier wave with a sinusoidal form that is 90° out of phase and the same predefined frequency. The first Q baseband signal may be multiplied with the first subcarrier wave with a cosine form. The first I baseband signal can be the real part signal of the complex signal. The first Q baseband signal can be the imaginary part signal of the complex signal. The first subcarrier wave can be either the in-phase carrier wave or quadrature carrier wave, depending on whether the I baseband signal or the Q baseband signal is being modulated. For the step of producing a first frequency-domain I/Q composite signal by combining the first modulated I baseband signal and the first modulated Q baseband signal, the first frequency-domain I/Q composite signal may be produced by the addition or sum of the first modulated I baseband signal and the first modulated Q baseband signal.

In at least one configuration of the circuit arrangement, the at least one transceiver is further configured to provide the first I/Q time-domain composite signal by performing an IFFT on the first frequency-domain I/Q composite signal. The first first-frequency domain I/Q composite signal may refer to one of the subcarrier signals of the OFDM or OFDMA system that carries one symbol. A single subcarrier that carries one symbol and occupies one time slot is defined as a resource element. The resource element is the smallest defined unit for allocating time-frequency resources in the physical layer of the communication model. The series of binary signal bits are encoded in different symbols and therefore are converted into parallel binary signal bits. The envelope change over time and the phase change over time of the first waveform in this configuration may represent one of the symbol intervals.

In at least one configuration of the circuit arrangement, the at least one transceiver is further configured to: provide the first I/Q time-domain composite signal by aggregating a plurality of first frequency-domain I/Q composite signals that are modulated onto a plurality of first subcarriers with a predetermined frequency spacing; and preforming an IFFT on the plurality of first frequency-domain I/Q composite signals. The plurality of first frequency-domain I/Q composite signals may refer to one of the subcarrier groups of the OFDM or OFDMA system that carries one group of symbols. The OFDM and OFDMA system can be implemented with different communication protocols, such as LTE, Wi-Fi, 5G NR and the like. To increase the transmission efficiency, there may be a group of subcarriers with a group of first subcarrier waves that carries a group of symbols in the OFDM and OFDMA system. The frequency of the first subcarrier waves in the group of first subcarriers waves may be separated by a predetermined frequency spacing according to different communication protocols. The predetermined frequency spacing can be determined for the LTE, Wi-Fi standards, or 5G NR systems. For example, in LTE, the adjacent first subcarrier waves may have a spacing of 15 kHz. In Wi-Fi standards, the adjacent first subcarrier waves may have a spacing of 78.125 kHz in Wi-Fi 6 or 312.5 kHz in 802.11ab/g/n/ac Wi-Fi standards. In 5G NR, the adjacent first subcarrier waves may be determined by the types of 5G NR numerology. For example, the spacing of the adjacent first subcarrier waves is 15 kHz when the numerology value is 0, the spacing is 30 kHz when the numerology value is 1, the spacing is 60 kHz when the numerology value is 2, etc. A transmission is scheduled in group(s) of 12 subcarriers and occupies one time slot, known as a physical resource block. The first time-domain I/Q composite signal can be obtained by preforming an IFFT on the plurality of first frequency-domain I/Q composite signals and represents a time-domain signal based on one resource block.

In at least one configuration of the circuit arrangement, the at least one transceiver is further configured to add a cyclic prefix related to the first time-domain I/Q composite signal to each symbol of the first time-domain I/Q composite signal. After the IFFT, a cyclic prefix, a copy of the end of each symbol, is added to each symbol to prevent inter-symbol interference, ISI, due to multipath fading in the wireless channel. The cyclic prefix can also be added to each group of symbols for a group of subcarriers in OFDM or OFDMA systems; in this case, the cyclic prefix refers to a copy of the end of each group of symbols.

In at least one configuration of the circuit arrangement, the at least one transceiver further comprises at least one up-converter configured to up-convert the doublet pair signal into a combined RF signal; at least one amplifier configured to amplify the combined RF signal to produce a transmitted RF signal; and at least one filter configured to filter the transmitted RF signal to produce an output RF signal. When modulating signals, especially at very high frequencies, e.g., in radio frequency or microwave communications, it is common to modulate the signal first at an intermediate frequency (IF), before up-converting it to the final carrier RF. IF may refer to the central frequency of the first subcarrier wave or the group of first subcarrier waves. This two-step process-modulating at IF, then converting to RF—renders signal processing easier and reduces complexity, especially in hardware design.

In an OFDM system, according to different communication protocols, there may be different subcarriers group that contains a different number of tones. For example, 12 subcarriers in one subcarriers group for the LTE protocols. Through digital signal processing, the whole group of the OFDM subcarrier is up-converted with a higher radio frequency. For the step of producing a transmitted RF signal by amplifying the combined RF signal, the transmit path in the transmit component comprises at least one first amplifier, in which the first amplifier is a power amplifier configured to amplify RF signals with low-power through the transmit path. Typically, power amplifiers are used with their output driving the antenna in the transmit mode. Power amplifiers ensure that the signal is boosted to a level suitable for efficient and reliable signals over long distances. For the step producing an output RF signal by filtering the transmitted RF signal, the transmit path in the transmit component comprising at least one first filter, in which a first filter is a transmit filter configured to filter RF signals through the transmit path. The transmit filter processes the RF signal before its transmission. During transmit signal processing, a series of operations, such as signal mixing, spectrum shaping and the like, are introduced. In this process, the entire transmission signal will introduce various unwanted harmonics or noise, increasing the adjacent channel interference and impairing the SNR. Therefore, the filter may be needed or desired to filter the unwanted interference or noise introduced in the transmit RF signal.

In at least one configuration of the circuit arrangement, the at least one amplifier comprises a power amplifier configured to amplify the combined RF signal with low-power through a transmit path. Typically, power amplifiers are used with their output driving the antenna in the transmit mode. Power amplifiers ensure that the signal is boosted to a level suitable for efficient and reliable signals over long distances. Design goals of the power amplifier often include gain, power output, bandwidth, power efficiency, linearity, input and output impedance matching, and heat dissipation.

In at least one configuration of the circuit arrangement, the at least one transceiver comprises at least one of the following: at least one digital signal processor (DSP); at least one microprocessor; at least one field-programmable gate array (FPGA); at least one application-specific integrated circuit (ASIC); or any combination thereof. A DSP is a specialized microprocessor chip and can process digital signals, such as audio, video or image data. In a wireless communication system, the DSP may execute a number of mathematical operations such as filtering, modulation, encoding or the like. DSPs may be fabricated on a metal-oxide-semiconductor (MOS) integrated circuit. An FPGA is a programmable integrated circuit that can be programmed to perform a function with flexibility. An FPGA allows the developers to customize the hardware to meet the specific need. An FPGA can also execute a number of mathematical operations such as filtering, modulation, encoding or the like. The additive value to using FPGA is that the functions of the FPGA can be reconfigurable, which offers significant flexibility during the hardware implementation of the constant envelope modulation. ASICs can be also used to conduct a number of mathematical operations such as filtering, modulation, encoding or the like. An ASIC is a custom-built chip designed for a specific function and typically used in situations where the power efficiency, the processing speed, and the cost are paramount. The general microprocessor can also be used to conduct a number of mathematical operations such as filtering, modulation, encoding or the like. However, the customized process for the constant envelope method may be longer than the other three integrated circuits mentioned above. They can be used in combination to achieve a balance between high performance, flexibility, efficiency and cost-effectiveness.

In at least one configuration of a mobile device, at least one user interface is arranged within an opening of the housing. The at least one user interface may be a screen attached to or at least partially embedded in the housing of the mobile device. The user interface is the space where interactions between human and hardware occur. The user interface can be a touch screen, a voice user interface, a gesture-based interface or the like.

In at least one configuration of the mobile device, the mobile device further comprises at least one battery and a power management unit arranged inside the housing. The at least one battery may serve as a primary power source supplying the electrical energy to the device. As an alternative, the at least one battery may serve as a back-up power source when the device needs to operate in the absence of external power. The power management unit may serve to regulate the power supply for to different components of the device. Therefore, the power supply unit can ensure the efficient energy use and the prevention of overcharging and undercharging. The power management unit may further comprises a thermal regulation unit, preventing the overheating of the device.

In at least one configuration of the mobile device, the mobile device further comprises a processing device, in which the processing device further comprises at least one of the following: a central processing unit (CPU); at least one memory; and a motherboard. The mobile device can also execute software applications. The CPU is the computational engine of the device, executing instructions and performing calculations for the running application. The at least one memory may be volatile or non-volatile. The information of the application on the device may also be stored on a cloud memory, which can achieve a simultaneous cooperation between multiple people. In this case, the memory may store only the permanent information on the device. Thus, the memory space can be largely saved and the equipment is more cost effective. The motherboard may serve as the main circuit board that interconnects the CPU, the at least one memory and other peripheral devices, enabling them to communicate and function cohesively. The mobile device can be implemented in or part of various electronic devices. Examples of electronic devices can include, but are not limited to, consumer electronic products, electronic test equipment, cellular communications infrastructure such as a base station, etc. Examples of electronic devices can also include, but are not limited to, a mobile phone such as a smart phone, a wearable computing device such as a smart watch or an ear piece, a telephone, a television, a computer monitor, a computer, a modem, a hand-held computer, a laptop computer, a table computer, a personal digital assistant, a microwave, a refrigerator, a vehicular electronic system such as an automotive electronics system, a stereo system, a DVD player, a CD player, a digital music player such as an MP3 player, a radio, a camcorder, a camera such as a digital camera, a portable memory chip, a washer, a dryer, a washer/dryer, peripheral devices, a clock, etc. Further, the electronic device can include unfinished products.

Where appropriate, the above-mentioned configurations and developments can be combined with each other as desired, as far as this is reasonable. Further possible configurations, developments and implementations of the invention also include combinations, which are not explicitly mentioned, of features of the invention which have been described previously or are described in the following with reference to the configuration s. In particular, in this case, a person skilled in the art will also assess individual aspects as improvements or supplements to the basic form of the present invention.

### BRIEF DESCRIPTION OF THE DRAWINGS

For a more comprehensive understanding of aspects and embodiments of the present disclosure and the advantages thereof, exemplary configurations of the present disclosure are explained in more detail in the following description with reference to the accompanying drawing figures, in which like reference characters designate like parts and in which:

FIG. 1 illustrates a schematic diagram of an example of a method for constant envelope modulation;

FIG. 2 illustrates a flow chart of an example for the steps of the method before providing the first time-domain I/Q composite signal;

FIG. 3A illustrates a flow chart of an example for the step of the first I/Q time-domain composite signal is provided from the first frequency-domain I/Q composite signal;

FIG. 3B illustrates a flow chart of another example for the steps of the first I/Q time-domain composite signal is provided from the first frequency-domain I/Q composite signal;

FIG. 4 illustrates a flow chart of an example of the step of after producing the first time-domain I/Q composite signal;

FIG. 5 illustrates a flow chart of an example of the steps operating with RF signal;

FIG. 6A illustrates a schematic diagram of an example of the circuit arrangement;

FIG. 6B illustrates a schematic diagram of another example of the circuit arrangement; and

FIG. 7 illustrates a schematic diagram of an example of the mobile device.

The appended drawings are intended to provide further understanding of the various aspects of the present disclosure. They illustrate various configurations and, in conjunction with the description, help to explain principles and concepts of the present disclosure. Other configurations and many of the advantages mentioned become apparent in view of the drawings. The elements in the drawings are not necessarily shown to scale. In the drawings, like functionally equivalent and identically operating elements, features and components are provided with like reference signs in each case, unless stated otherwise.

### DETAILED DESCRIPTION

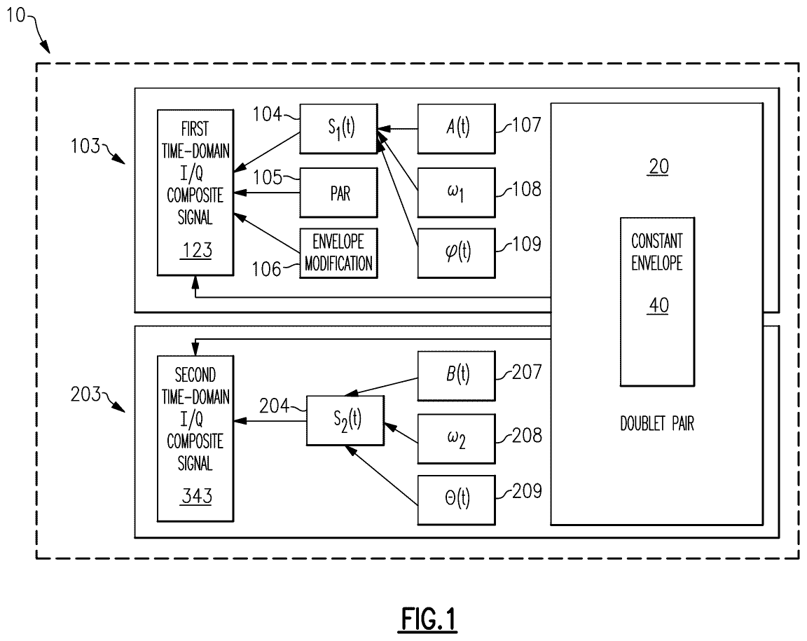

FIG. 1 illustrates a schematic diagram of an example of a method for constant envelope modulation. The method for constant envelope modulation in FIG. 1 is denoted by reference numeral 10. The method for constant envelope modulation 10 shown in FIG. 1 includes two basic steps: step 103 for producing a first time-domain I/Q composite signal 123 and step 203 for producing a second time-domain I/Q composite signal 343. The first time-domain I/Q composite signal 123 is described by a first waveform 104, S₁(t)=A(t) cos (ω₁t+φ(t)), in which the first time-domain I/Q composite signal 123 contains an intended high order modulation with a high PAR 105 and an envelope modulation as a function of time 106. The second time-domain I/Q composite signal 343 is described by a second waveform 204, S₂(t)=B(t) cos (ω₂t+θ(t)), in which an envelope change over time 207 and a phase change over time 209 of the second waveform 204 are defined as a function of the first waveform 104. A(t) and B(t) represent the envelope change over time of the first time-domain I/Q composite signal 123 and the envelope change over time of the second time-domain I/Q composite signal 343, respectively, ω₁ and ω₂ represent an angular frequency of the first time-domain I/Q composite signal 108 and the angular frequency second time-domain I/Q composite signal 208, respectively, and φ(t) and θ(t) represent the phase change over time of the first time-domain I/Q composite signal 109 and the phase change over time of the second time-domain I/Q composite signal 209, respectively. The first time-domain I/Q composite signal 123 and the second time-domain I/Q composite signal 343 are combined to a doublet pair signal 20. The sum of the first waveform 104 and the second waveform 204 results in a constant envelope 40.

ω₁ and ω₂ are separated by a predefined difference. As commonly known, an angular frequency ω can be represented by 2πf, including an ordinary frequency f. The frequency of the first subcarrier wave and the second subcarrier wave are represented by the ordinary frequency f₁ and the ordinary frequency f₂ linked with ω₁ and ω₂, respectively. Therefore, f₁ and f₂ are also separated by a predefined difference. The predefined difference between f₁ and f₂ is defined as the composition of the offset of f₁ from the local frequency at one side and the offset of f₂ from the local frequency at the other side, in which those two offsets are symmetric. The local frequency can be defined as the central frequency of one of the subcarriers or one of the groups of subcarriers. The predefined difference between f₁ and f₂ is time-dependent and also depends on the location of the offset of f₁ from the local frequency. In other words, different doublet pair signals 20 may have different predefined differences between f₁ and f₂. Therefore, the flexibility of the subcarrier frequency adjustment of different doublet pair signals 20 is realized. The change of f₂ can follow the change of f₁, thus, the dependency of the second waveform 204 on the first waveform 104 is also realized.

The envelope change over time of the second waveform 207 and the phase change over time of the second waveform 209 are designed to be directly dependent on the first waveform 104. For example, the envelope change over time of the second time-domain I/Q composite signal 207B(t) is represented by:

$$B ( t ) = \frac{1 - A ( t ) cos ( {ω}_{1} t + φ ( t ) )}{cos ( {ω}_{2} t + θ ( t ) )} .$$

The phase change over time of the first time-domain I/Q composite signal 109 and the phase change over time of second time-domain I/Q composite signal 209 fulfil at least one of the following correlations: θ(t)=φ(t);

$$θ ( t ) = \frac{π}{2} - φ ( t ) ;$$

and θ(t)=π−φ(t). A(t). The envelope change over time of the first time-domain I/Q composite signal 107 and φ(t), the phase change over time of the first time-domain I/Q composite signal 207 are modulated as normalized and nominal targeted values of the doublet pair signal 20. The property of high PAR 105 and the envelope variation of the first waveform 106 are also inherited, which means the source information of the first time-domain I/Q composite signal 103 is also inherited, but the average power of the first time-domain I/Q composite signal 103 is below a predefined constant value. The predefined constant value may be referred to a constant saturation power of a power amplifier located in the transmit path. In this case, the predefined constant value can be presupposed as 1, as the common value chosen by a number of other normalization processes. Depending on the magnitude of the constant saturation power of the power amplifier, other predefined constant values can also be selected.

The second waveform 204 is entirely dependent on the first waveform 104. Other correlations between the phase change over time of the first time-domain I/Q composite signal 109 and the phase change over time of the second time-domain I/Q composite signal 209, and between the envelope change over time of the first time-domain I/Q composite signal 107 and the envelope change over time of the second time-domain I/Q composite signal 207 can also be selected. It is sufficient that those correlations fulfil the requirements of the constant envelope modulation method described in this disclosure. The source information is carried by the first waveform 104. The second waveform 204 is generated dependent on the first waveform 14 without the need to transfer additional source information. Thus, the generation of the second waveform 204 may be completed based on the frequency 108, envelope change over time 107, and phase change over time of the first waveform 109, rather than being generated from the additional source information added to the transmission information. The generation of the second waveform 204 may require the use of a few digital signal processing steps after the first time-domain I/Q composite signal 103 is produced from the first frequency-domain I/Q composite signal. The method may apply QAM and/or QPSK as modulation schemes, and may be employed in FDM, OFDM, and/or OFDMA.

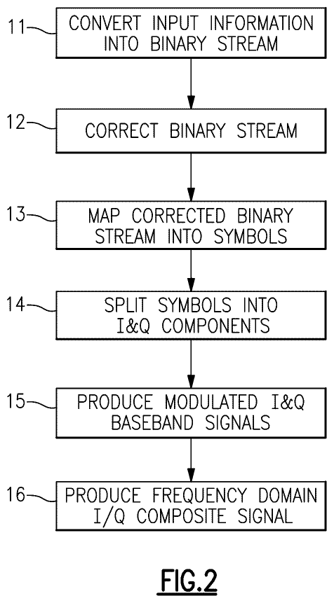

FIG. 2 illustrates a flow chart of an example for the steps of the method before providing the first time-domain I/Q composite signal 103. Before providing the first time-domain I/Q composite signal 103, the method 10 comprises converting first input information into a first binary stream 11, correcting the first binary stream into a corrected first binary stream 12, mapping the corrected first binary stream into symbols 13, and providing the first I baseband signal and the first Q baseband signal by splitting symbols into I and Q components 14. The step of converting first input information into a first binary stream 11 may also be called source coding. The first input information may be any analog signals or digital signals that can be measured or otherwise be obtained, for example, text, voice, notes, images, videos, or the like. The analog signals need to be converted into a binary stream using at least one analog-to-digital converter, ADC, such that the signal can be processed with processors. This could involve compressing and encoding the original analog data using techniques such as Huffman coding, JPEG, or other forms of source coding. The step of correcting the first binary stream 12 can be referred to as altering or adjusting the binary stream so as to bring it into accordance with a standard or with a required condition that is less prone to errors or less sensitive to noise. The step of correcting the first binary stream into a corrected first binary stream 12 can comprise a plurality of steps, such as a channel coding step, an interleaving step, a scrambling step, and other steps that can be used to correct the binary stream. The first binary stream may be the binary stream that was transformed from an analog signal, or may be digital signals obtained directly from the source of information.

The channel coding step can be referred to as introducing extra binary bits that help to detect and correct potential errors introduced by noise and interference during the signal transmission.

In the interleaving step, the binary stream with the extra binary bits is rearranged, such that binary stream is less susceptible to burst errors by spreading out errors over time, improving the performance of the error correction process.

In the scrambling step, the binary stream is processed to ensure that the signal has a more uniform distribution of ones and zeros, which is beneficial for clock recovery and reduces the likelihood of long sequences of the same bits.

The step of mapping the corrected first binary stream into symbols, step 13, may be referred to as mapping the encoded bits into symbols which represent different amplitude and phase combinations for QAM. The signal bits are mapped to the constellation diagram and each point in the constellation diagram is known as a symbol.

The step of providing the first I baseband signal and the first Q baseband signal by splitting symbols into I and Q components, step 14, refers to the representation of a symbol by a complex signal on the constellation diagram. A complex signal is a two-dimensional (2D) signal whose value can be specified by a single complex number having two parts: the real part and the imaginary part. The real part signal and the imaginary part signal can be modulated onto the in-phase carrier wave and quadrature carrier wave, respectively.

Before providing the first time-domain I/Q composite signal 103, the method 10 further comprises producing a first modulated I baseband signal and a first modulated Q baseband signal by modulating the first I baseband signal and the first Q baseband signal onto a first subcarrier wave, respectively 15, and producing a first frequency-domain I/Q composite signal by combining the first modulated I baseband signal and the first modulated Q baseband signal 16. For the step of producing a first modulated I baseband signal and a first modulated Q baseband signal by modulating the first I baseband signal and the first Q baseband signal onto a first subcarrier wave 15, the first I baseband signal is multiplied by the first subcarrier wave with a sinusoidal form that has a predefined frequency, the first Q baseband signal is multiplied by the first subcarrier wave with a sinusoidal form that is 90° out of phase and the same predefined frequency. The first Q baseband signal may be multiplied by the first subcarrier wave with a cosine form. The first I baseband signal can be the real part of the complex signal. The first Q baseband signal can be the imaginary part of the complex signal. The first subcarrier wave can be either the in-phase carrier wave or quadrature carrier wave, depending on whether I baseband signal or Q baseband signal is being modulated. For the step producing a first frequency-domain I/Q composite signal by combining the first modulated I baseband signal and the first modulated Q baseband signal 16, the first frequency-domain I/Q composite signal may be produced by the addition or sum of the first modulated I baseband signal and the first modulated Q baseband signal.

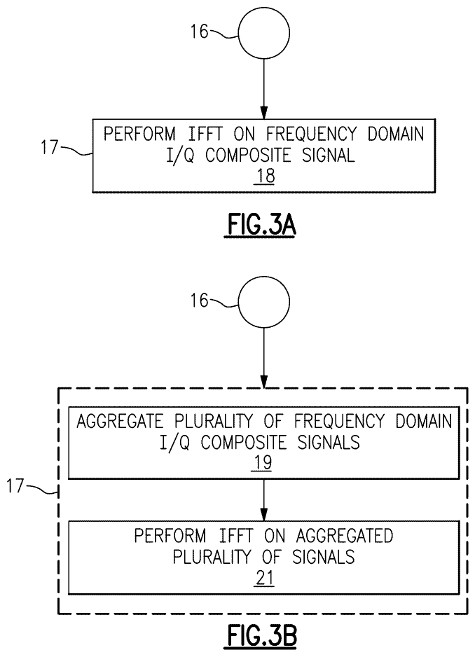

FIG. 3A illustrates a flow chart of an example for the step of the first I/Q time-domain composite signal 103 being provided from the first frequency-domain I/Q composite signal 17. This step 17 may be considered as a subsequent step to the step 16. The first I/Q time-domain composite signal 103 is provided by performing an Inverse Fast Fourier Transform (IFFT) on the first frequency-domain I/Q composite signal 18. The first first-frequency domain I/Q composite signal may refer to one of the subcarrier signals of the OFDM or OFDMA system that carries one symbol. A single subcarrier that carries one symbol and occupies one time slot is defined as a resource element. The resource element is the smallest defined unit for allocating time-frequency resources in the physical layer of the communication model. The series binary signal bits are encoded in different symbols and therefore converted into parallel binary signal bits. The envelope change over time and the phase change over time of the first waveform in this possible configuration may represent one of the symbol intervals.

FIG. 3B illustrates a flow chart of another example for the step of the first I/Q time-domain composite signal 103 being provided from the first frequency-domain I/Q composite signal. This step 17 may be considered as a subsequent step of the step 16. The first I/Q time-domain composite signal is further provided by aggregating a plurality of first frequency-domain I/Q composite signals that are modulated onto a plurality of first subcarriers with a predetermined frequency spacing 19 and performing an IFFT on the plurality of first frequency-domain I/Q composite signals 21. The plurality of first frequency-domain I/Q composite signal may refer to one of the subcarrier groups of the OFDM or OFDMA system that carries one group of symbols. The OFDM and OFDMA system can be implemented with different communication protocols, such as LTE, Wi-Fi, 5G NR and the like. To increase the transmission efficiency, there may be a group of subcarriers with a group of first subcarrier waves that carries a group of symbols in the OFDM or OFDMA system. The frequency of the first subcarrier waves in the group of first subcarrier waves may be separated by a predetermined frequency spacing according to different communication protocols. The predetermined frequency spacing can be determined for the LTE, Wi-Fi standards, or 5G NR systems. For example, in LTE, the adjacent first subcarrier waves may have a spacing of 15 kHz. In Wi-Fi standards, the adjacent first subcarrier waves may have a spacing of 78.125 kHz in Wi-Fi 6, or 312.5 kHz in 802.11ab/g/n/ac Wi-Fi standards. In 5G NR, the adjacent first subcarrier waves may be determined by the types of 5G NR numerology. For example, the spacing of the adjacent first subcarrier waves is 15 kHz when the numerology value is 0, the spacing is 30 kHz when the numerology value is 1, the spacing is 60 kHz when the numerology value is 2, etc. A transmission is scheduled in group(s) of 12 subcarriers and occupies one time slot, known as a physical resource block. The first time-domain I/Q composite signal 103 can be obtained by preforming an IFFT on the plurality of first frequency-domain I/Q composite signals and represents a time-domain signal based on one resource block.

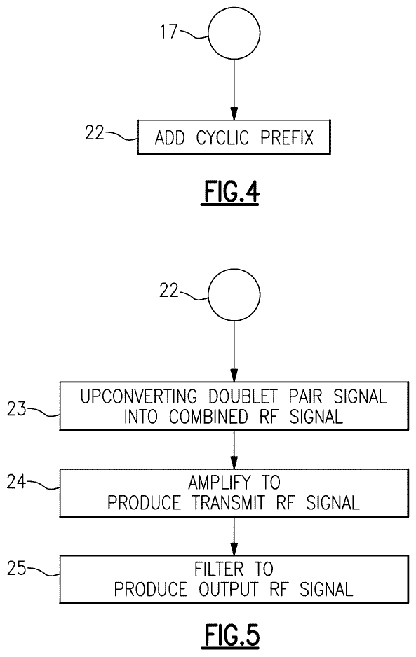

FIG. 4 illustrates a flow chart of an example of the step after producing the first time-domain I/Q composite signal. This step may be considered as a subsequent step to the step 17. After producing the first time-domain I/Q composite signal, the method further comprises adding a cyclic prefix related to the first time-domain I/Q composite signal to each symbol of the first time-domain I/Q composite signal, step 22. After the IFFT, a cyclic prefix (a copy of the end of each symbol) may be added to each symbol to prevent inter-symbol interference, ISI, due to multipath fading in the wireless channel. The cyclic prefix can also be added to each group of symbols for a group of subcarriers in an OFDM or OFDMA system; in this case, the cyclic prefix refers to a copy of the end of each group of symbols. During this step 22, the second waveform 204 may also be introduced with a certain number of extra waveform segments, called redundancy. The second waveform 204 is generated in dependence on the first waveform. The introduced extra waveform segments of the second waveform 204 may allow redundant waveform segments to be corrected in time due to transient errors. On the other hand, the redundancy introduced in the second waveform 204 may further be used to provide waveform diversity, such that the second waveform 204 may adapt with the change of the first waveform 104 with more flexibility. The change of the first waveform 104 may be present due to the transient errors or the requirement for adapting different over-the-air channels.

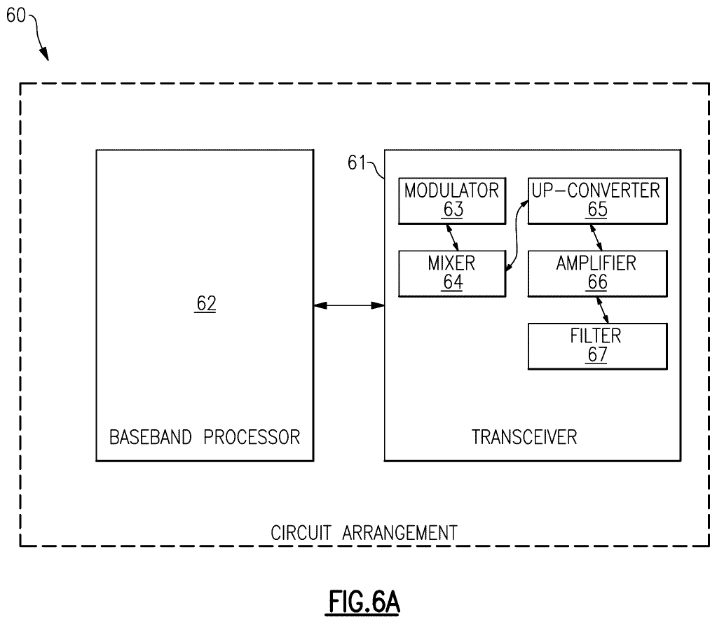

FIG. 5 illustrates a flow chart of an example of the steps of operating with an RF signal. These steps may be considered as subsequent steps of the step 22. The method 10 further comprises up-converting the doublet pair signal into a combined RF signal 23; producing a transmit RF signal by amplifying the combined RF signal 24; and producing an output RF signal by filtering the transmit RF signal 25. When modulating signals, especially at very high frequencies, e.g., in radio frequency or microwave communications, it is common to modulate the signal first at an intermediate frequency, IF, before up-converting it to the final carrier frequency. IF may refer to the central frequency of first subcarrier wave or the group of first subcarrier waves.

This two-step process-modulating at IF, then converting to RF-makes signal processing easier and reduces complexity, especially in hardware design. In OFDM systems, according to different communication protocols, there may be different subcarrier groups that contain different numbers of tones. For example, 12 subcarriers in one subcarrier group for the LTE protocols. Through digital signal processing, the whole group of the OFDM subcarrier is up-converted with a higher radio frequency. For the step producing a transmit RF signal by amplifying the combined RF signal 24, the transmit path in the transmit component comprises at least one amplifier, in which the amplifier is a power amplifier configured to amplify RF signals with low-power through the transmit path.

Typically, power amplifiers are used with their output driving the antenna in the transmit mode. Power amplifiers ensure that the signal is boosted to a level suitable for efficient and reliable signals over long distances. For the step producing an output RF signal by filtering the transmit RF signal 25, the transmit path in the transmit component comprising at least one filter, in which the filter is a transmit filter configured to filter RF signals through the transmit path. The transmit filter processes the RF signal before its transmission. During transmit signal processing, a series of operations, such as signal mixing, spectrum shaping and the like, are introduced. In this process, the entire transmission signal will introduce various unwanted harmonics or noise, increasing the adjacent channel interference and impairing the SNR. Therefore, the filter may need to filter the unwanted interference or noise introduced in the transmit RF signal.

The doublet pair signal 20 comprises an available bandwidth. The first waveform 104 uses a first half of the available bandwidth. The first waveform 104 contains the input information that the user actually want to transmit. The second waveform 204 is designed to adapt to the first waveform 104 to cancel the envelop change over time of the doublet pair signal 20, such as to enable a constant envelope transmission. Therefore, the second waveform 204 does not contain additional information that the user want to transmit, instead, the second waveform 204 can be considered as also carrying the same information encoding of the first waveform 104.

For a doublet pair signal 20, the first waveform 104 only takes a half of the available bandwidth of the doublet pair signal 20. The second waveform 204 uses the second half of the available bandwidth. The predefined difference of f₁ and f₂ is defined as two symmetric offset from respective f₁ and f₂ to local frequency, thus the predefined difference can be considered as the available bandwidth of the doublet pair signal 20. Since the first half of the bandwidth is taken by the first waveform 104, the second half of the bandwidth is taken by the second waveform 204. The total bandwidth of a transmit channel is made up by packing with every doublet pair signal 20.

Each resource element or resource block of the OFDM or OFDMA system can refer to a doublet pair signal 20. Each doublet pair signal 20 has its available bandwidth, the whole bandwidth of the transmit channel is aggregated with each doublet pair signal. The transmit channel with a plurality of doublet pair signals 20 comprises a property of the constant envelope. The first waveform 104 may be modulated as a nominal targeted value of the doublet pair signal, the second waveform 204 is designed in dependence on the first waveform 104 to result in a constant envelope 40. The whole transmitting channel is aggregated with each doublet pair signal 20 with the constant envelope 40. Therefore, the whole transmit channel also has the constant envelope. Since the whole transmit channel also has the constant envelope 40, the envelope of the time-domain signal over time is also constant. Thus, the method operates without AM noise contribution.

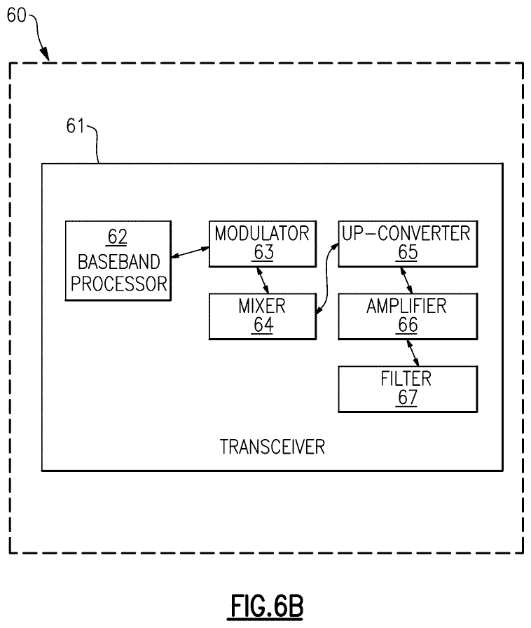

FIG. 6A illustrates a schematic diagram of an example of a circuit arrangement 60 in accordance with the present disclosure. In FIG. 6A, the circuit arrangement 60 comprises a transceiver 61 and a baseband processor 62 coupled to the transceiver 61. FIG. 6B illustrates a schematic diagram of another example of the circuit arrangement. In FIG. 6B, the circuit arrangement 60 comprises a transceiver 61 and a baseband processor 62 being a part of the transceiver 61. In both FIGS. 6A and 6B, the transceiver 61 may further comprise a modulator 63, a mixer 64, an up-converter 65, an amplifier 66, and a filter 67.

At a transmit path, a baseband processor 62 usually allows the source information to be processed in the digital domain between the source of the information and the transceiver device 61. A transceiver 61 is a combination of a transmitter and a receiver in a single unit or in a device. In a transmit path, the transceiver is the transmitter of the communication system and is an interface between the signal in the digital domain and the signal in the RF analog domain. In some technical jargons, a transceiver 61 may be termed a modem, since a modem-similar to a transceiver 61—is also configured to send and receive signals. With the development of the integrated circuit, the boundaries between the baseband processor 62 and the transceiver 61 are becoming blurred. A baseband processor 62 can be part of the transceiver; a transceiver 61 can also be part of the baseband processor 62. Therefore, it is possible that the functions performed by baseband processor 62 and transceiver 61 in this application are mutually inclusive.

The baseband processor 62 may be configured to convert a first input information into a first binary stream 11; to correct the first binary stream into a corrected first binary stream 12; to map the corrected first binary stream into symbols 13; and to provide the first I baseband signal and the first Q baseband signal by splitting symbols into I and Q components 14.

The transceiver 61 may be configured to produce a first modulated I baseband signal and a first modulated Q baseband signal by modulating the first I baseband signal and the first Q baseband signal onto a first subcarrier wave, respectively 15, produce a first frequency-domain I/Q composite signal by combining the first modulated I baseband signal and the first modulated Q baseband signal 16. The modulator 63 may be configured to produce a modulated first I baseband signal and a modulated first Q baseband signal by modulating the first I baseband signal and the first Q baseband signal onto a first subcarrier wave, respectively 15. The mixer 64 may be configured to combine the modulated first I baseband signal and the modulated first Q baseband signal to produce a first frequency-domain I/Q composite signal 16.

The transceiver 61 may be further configured to provide the first I/Q time-domain composite signal 17 by performing an IFFT on the first frequency-domain I/Q composite signal, or to provide the first I/Q time-domain composite signal by: aggregating a plurality of first frequency-domain I/Q composite signals that are modulated onto a plurality of first subcarriers with a predetermined frequency spacing 19; and preforming IFFT on the plurality of first frequency-domain I/Q composite signals 21.

The transceiver 61 may be further configured to add a cyclic prefix related to the first time-domain I/Q composite signal to each symbol of the first time-domain I/Q composite signal 22. The up-converter 65 may be configured to up-convert the doublet pair signal into a combined RF signal 23. The amplifier 66 may be configured to amplify the combined RF signal to produce a transmitted RF signal 24. The amplifier 66 can be a power amplifier configured to amplify RF signals with low-power through the transmit path. Typically, power amplifiers 66 are used with their output driving the antenna in the transmit mode. Power amplifiers 66 ensure that the signal is boosted to a level suitable for efficient and reliable signals over long distances. And the filter 67 may be configured to filter the transmitted RF signal to produce an output RF signal 25. The filter 67 can be a transmit filter 67 configured to filter RF signals through the transmit path. The transmit filter 67 processes the RF signal before its transmission. During transmit signal processing, a series of operations, such as signal mixing, spectrum shaping and the like, are introduced. In this process, the entire transmission signal will introduce various unwanted harmonics or noise, increasing the adjacent channel interference and impairing the SNR. Therefore, the filter 67 may be needed or desired to filter the unwanted interference or noise introduced in the transmit RF signal. The transceiver 61 may comprise at least one DSP; at least one microprocessor; at least one FPGA; at least one ASIC; or any combination thereof.

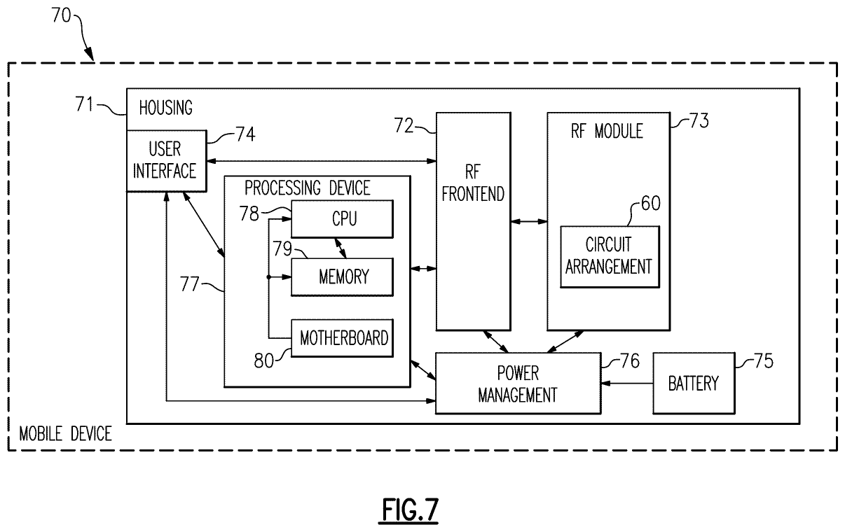

FIG. 7 illustrates a schematic diagram of an example of a mobile device 70 in accordance with the present disclosure. The mobile device 70 comprises a housing 71, a RF front-end circuit 72 arranged in the housing 71, and an RF module 73 arranged in the housing 71. The RF module 73 comprises a circuit arrangement 60. The mobile device 10 further comprises a user interface 74 arranged within an opening of the housing 71, a battery 75 and a power management unit 76 arranged inside the housing 71, and a processing device 77, in which the processing device 77 further comprises a CPU 78, a memory 79, and a motherboard 80. The user interface 74 may be a screen attached to or at least partially embedded in the housing 71 of the mobile device 70. The user interface 74 is the space where interactions between human and hardware occur. The user interface 74 can be a touch screen, a voice user interface, a gesture-based interface or the like. The battery 75 may serve as a primary power source supplying the electrical energy to the device 70. As an alternative, the battery 75 may serve as a back-up power source when the device 70 needs to operate in the absence of external power. The power management unit 76 may serve as a management unit that regulates the power supply for different components of the device 70. Therefore, the power management unit 76 can ensure efficient energy use and the prevention of overcharging and undercharging. The power management unit 76 may further comprise a thermal regulation unit, preventing the overheating of the device 70. The CPU 78 is the computational engine of the device 70, executing instructions and performing calculations for the running application. The memory 79 may be volatile or non-volatile. The information of the application on the device may also be stored on a cloud memory, which can achieve a simultaneous cooperation between multiple people. In this case, the memory 79 may store only the permanent information on the device. Thus, the memory 79 space can be largely saved and the equipment is more cost effective. The motherboard 80 may serve as the main circuit board that interconnects the CPU 78, the memory 79 and other peripheral devices, enabling them to communicate and function cohesively.

The mobile device 70 can be implemented in or part of various electronic devices: examples of the electronic devices can include, but are not limited to, consumer electronic products, electronic test equipment, cellular communications infrastructure such as a base station, etc. Examples of the electronic device can further include, but are not limited to, a mobile phone such as a smart phone, a wearable computing device such as a smart watch or an ear piece, a telephone, a television, a computer monitor, a computer, a modem, a hand-held computer, a laptop computer, a table computer, a personal digital assistant, a microwave, a refrigerator, a vehicular electronic system such as an automotive electronics system, a stereo system, a DVD player, a CD player, a digital music player such as an MP3 player, a radio, a camcorder, a camera such as a digital camera, a portable memory chip, a washer, a dryer, a washer/dryer, peripheral devices, a clock, etc. Further, the electronic devices can include unfinished products.

Some of the configurations described above have provided examples in connection with RF components, and/or mobile devices. However, the principles and advantages of the configurations can be used for any other systems or apparats that could benefit from any of the circuits described herein. Although described in the context of RF circuits, one or more features described herein can also be utilized in packaging applications involving non-RF components. Similarly, one or more features described herein can also be utilized in packaging applications without electromagnetic isolation functionality. Any of the principles and advantages of the configurations discussed can be used in any other systems or apparatus that could benefit from the antenna and/or the shielding structures discussed herein.

Unless the context clearly requires otherwise, throughout the description and the claims, the words “comprise,” “comprising,” “include,” “including” and the like are to be constructed in an inclusive sense, as opposed to an exclusive or exhaustive sense; that is to say, in the sense of “including, but not limited to.” The word “arranged”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, fall refer to this application as a whole and not to any particular portions of this application. Where the context permits, words in the above detailed description of certain configurations using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain configurations include, while other configurations do not include, certain features, elements and/or states. Thus, such conditional language is not generally intended to imply that features, elements and/or states are in any way required for one or more configurations or whether these features, elements and/or states are included or are to be performed in any particular configuration.

While certain configurations have been described, these configurations have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative configurations may perform similar functionalities with different components and/or circuit topologies, and same blocks may be deleted, moved, added, subdivided, combined, and/or modified. Each of these blocks may be implemented in a variety of different ways.

Any suitable combination of the elements and acts of the various configurations described above can be combined to provide further configurations. The accompanying claims and their equivalents are intended to cover such forms or modifications as would fall within the scope and spirit of the disclosure.

What is claimed is:

1. A method for constant envelope modulation, the method comprising:
processing a first time-domain in-phase and quadrature (I/Q) composite signal, the first time-domain I/Q composite signal being described by a first waveform S₁(t)=A(t) cos (ω₁t+φ(t)) and containing an intended high order modulation with a high peak-to-average ratio (PAR) and an envelope modulation as a function of time, A(t) representing the envelope change over time, ω₁ representing an angular frequency, and φ(t) representing the phase change over time;
processing a second time-domain I/Q composite signal, the second time-domain I/Q composite signal being described by a second waveform S₂(t)=B(t) cos (ω₂t+θ(t)), with an envelope change over time and a phase change over time of the second waveform defined as a function of the first waveform, B(t) representing the envelope change over time, ω₂ representing an angular frequency, and θ(t) representing the phase change over time;
combining the first time-domain I/Q composite signal and the second time-domain I/Q composite signal into a doublet pair signal; and
forming a sum of the first waveform and the second waveform to obtain a constant envelope.

2. The method of claim 1 wherein ω₁ and ω₂ are spaced apart by a predefined difference value.

3. The method of claim 1 wherein B(t) is represented by:
$$B ( t ) = \frac{1 - A ( t ) cos ( {ω}_{1} t + φ ( t ) )}{cos ( {ω}_{2} t + θ ( t ) )} ,$$
the phase change over time of the first time-domain I/Q composite signal and the second time-domain I/Q composite signal fulfilling at least one of the following correlations:
$$θ ( t ) = φ ( t ) ;$$
$$θ ( t ) = \frac{π}{2} - φ ( t ) ; and$$
$$θ ( t ) = π - φ ( t ) .$$

4. The method of claim 1 wherein the method is applied in at least one of a quadrature amplitude modulation (QAM) scheme and a quadrature phase-shift keying (QPSK) scheme.

5. The method of claim 1 wherein the method is applied in at least one of frequency-division multiplexing (FDM), orthogonal frequency-division multiplexing (OFDM), and orthogonal frequency-division multiple access (OFDMA).

6. The method of claim 1 wherein processing the first time-domain I/Q composite signal includes converting first input information into a first binary stream, correcting the first binary stream into a corrected first binary stream, mapping the corrected first binary stream onto symbols, and providing a first I baseband signal and a first Q baseband signal by splitting the symbols into I and Q components.

7. The method of claim 1 wherein processing the first time-domain I/Q composite signal includes generating a first modulated I baseband signal and a first modulated Q baseband signal by modulating the first I baseband signal and the first Q baseband signal onto a first subcarrier wave, respectively, and generating a first frequency-domain I/Q composite signal by combining the first modulated I baseband signal and the first modulated Q baseband signal.

8. The method of claim 7 wherein the first time-domain I/Q composite signal is generated by performing an inverted fast Fourier transformation (IFFT) on the first frequency-domain I/Q composite signal.

9. The method of claim 7 wherein the first time-domain I/Q composite signal is generated by aggregating a plurality of first frequency-domain I/Q composite signals that are modulated onto a plurality of first subcarriers with a predetermined frequency spacing, and performing an IFFT on the plurality of first frequency-domain I/Q composite signals.

10. The method of claim 1 further comprising adding a cyclic prefix related to the first time-domain I/Q composite signal to each symbol of the first time-domain I/Q composite signal.

11. The method of claim 1 wherein the redundancy of the second waveform introduces waveform diversity, thereby dynamically adapting the second waveform to the first waveform.

12. The method of claim 1 further comprising:
up-converting the doublet pair signal into a combined radio-frequency (RF) signal;
generating a transmit RF signal by amplifying the combined RF signal; and
generating an output RF signal by filtering the transmit RF signal.

13. The method of claim 1 wherein the doublet pair signal includes an available bandwidth, the first waveform using a first half of the available bandwidth, and the second waveform uses a second half of the available bandwidth.

14. The method of claim 13 wherein the method operates without amplitude modulation (AM) noise contribution.

15. A circuit arrangement for constant envelope modulation, the circuit arrangement comprising at least one transceiver that is configured to:
process a first time-domain in-phase and quadrature (I/Q) composite signal, the first time-domain I/Q composite signal being described by a first waveform S₁(t)=A(t) cos (ω₁t+4(t)) and containing an intended high order modulation with a high peak-to-average ratio (PAR) and an envelope modulation as a function of time, A(t) representing the envelope change over time, ω₁ representing an angular frequency, and φ(t) representing the phase change over time;
process a second time-domain I/Q composite signal, the second time-domain I/Q composite signal being described by a second waveform S₂(t)=B(t) cos (ω₂t+θ(t)), with an envelope change over time and a phase change over time of the second waveform defined as a function of the first waveform, B(t) representing the envelope change over time, ω₂ representing an angular frequency, and θ(t) representing the phase change over time;
combine the first time-domain I/Q composite signal and the second time-domain I/Q composite signal into a doublet pair signal; and
form a sum of the first waveform and the second waveform to obtain a constant envelope.

16. The circuit arrangement of claim 15 further comprising at least one baseband processor coupled to or being a part of the at least one transceiver.

17. The circuit arrangement of claim 16 wherein the at least one baseband processor is configured to:
convert first input information into a first binary stream;
correct the first binary stream into a corrected first binary stream;
map the corrected first binary stream onto symbols; and
generate a first I baseband signal and a first Q baseband signal by splitting the symbols into I and Q components.

18. The circuit arrangement of claim 15 wherein the at least one transceiver is further configured to:
generate a first modulated I baseband signal and a first modulated Q baseband signal by modulating the first I baseband signal and the first Q baseband signal onto a first subcarrier wave, respectively; and
generate a first frequency-domain I/Q composite signal by combining the first modulated I baseband signal and the first modulated Q baseband signal.

19. The circuit arrangement of claim 18 wherein the at least one transceiver is further configured to generate the first I/Q time-domain composite signal by aggregating a plurality of first frequency-domain I/Q composite signals that are modulated onto a plurality of first subcarriers with a predetermined frequency spacing, and performing an IFFT on the plurality of first frequency-domain I/Q composite signals.

20. The circuit arrangement of claim 15, wherein the at least one transceiver further includes at least one up-converter configured to up-convert the doublet pair signal into a combined RF signal, at least one amplifier configured to amplify the combined RF signal to generate a transmitted RF signal, and at least one filter configured to filter the transmitted RF signal to generate an output RF signal.
